(19) United States
(12) Patent Application Publication
(10) Pub. No.: US 2008/0264723 A1
(43) Pub. Date: Oct. 30, 2008

(54) Step stool

(76) Inventors: Mary K. Tatum, Manitou Springs, CO (US); Tamara A. Bartlett, Manitou Springs, CO (US)

Correspondence Address: JAMES RAY & ASSOCIATES, 2640 Pitcairn Road, Monroeville, PA, 15146, US

(21) Appl. No.: 12/148,838

(22) Filed: Apr. 23, 2008

Related U.S. Application Data
(60) Provisional application No. 60/926,132, filed on Apr. 25, 2007.

(51) Int. Cl. E06C 1/00; A47B 88/04; A47B 77/10

(52) U.S. Cl. 182/35

(57) ABSTRACT

A step stool for storing underneath a cabinet and extending therefrom when in use is provided. Such step stool includes a platform member for supporting a user. Such platform member being manufactured from a first predetermined material and having a first predetermined size and a first predetermined shape. A mechanism is operably disposed on at least one of a bottom portion of such platform member and at least one side of such platform member at a first predetermined location thereon for facilitating movement of the step stool such that the step stool may be extended from underneath such cabinet for use and may be returned to a position underneath such cabinet for storage.

### CROSS REFERENCE TO RELATED APPLICATION

This patent application is related to and claims priority from U.S. Provisional Patent Application Ser. No. 60/926,132 filed Apr. 25, 2007.

### FIELD OF THE INVENTION

The present invention relates, in general, to step stools and, more particularly, this invention relates to step stools which may be stored underneath cabinets.

### BACKGROUND OF THE INVENTION

Prior to the conception and development of the present invention, step stools, as are generally well known in the prior art, have been used to permit users to obtain things that would otherwise be unreachable. Generally, step stools are transported to the necessary location, unfolded or simply set in place and the user steps up and reaches for the needed item. This can often be inconvenient since the step stool may be stored in an inconvenient location and may also be heavy and cumbersome. Additionally the step stool may scratch cabinetry and flooring. A need exists for a step stool which is easily stored and is quickly available at little or no inconvenience to the user and which will not cause damage to flooring and cabinetry.

Specifically of interest to the present invention are the following: Anderson, U.S. Pat. No. 5,005,667, discloses an extensible and retractable step assembly for a floor cabinet having an open rectangular base slidably mounted in an interior space at the bottom of the cabinet immediately above the floor and selectively positionable in the cabinet or in front of the cabinet, a step which fits inside this base, and slidable pivoted linkages connecting the step to the base and permitting the step to be raised up from the base when the base is extended in front of the cabinet.

Lundry, U.S. Pat. No. 6,425,457, discloses a collapsible step assembly for storing in a drawer of a cabinet. The collapsible step assembly includes a staircase for ascending and descending from a surface. A drawer assembly is provided for pivotally storing the staircase under the cabinet.

Callahan, U.S. patent application Ser. No. 9/941,430, Pub. No. 2002/0047505, discloses a new and improved attachable cabinet shelf for storing a step stool or other piece of equipment. The cabinet shelf would be attached to the underside of a fixed cabinet shelf within a cabinet. Space would be present between the present invention and the fixed cabinet shelf in which to store a step stool or other important equipment that would frequently be needed.

Kalos, U.S. patent application Ser. No. 10/462,338, Pub. No. 2004/0251080 discloses an extensible and retractable step assembly that has a base and a first step. The step is attached to one end of the base and rotates up on the base. The step has first and second stepping surfaces for reaching different heights. The step assembly may be inserted before or after the cabinet is installed.

Arnold, U.S. patent application Ser. No. 9/781,015, Pub. No. 2002/0109446, discloses a system and method for providing a stepping platform in front of a cabinet structure. The system includes a motorized platform that is retracted into the base support below the cabinet structure. When a person needs the platform, that person engages an activation switch. Once the activation switch is depressed, an electric motor drives the platform forward in front of the cabinet structure. When the platform is no longer needed, the activation switch is again engaged. The electric motor retracts the platform back into the base support below the cabinet structure.

### SUMMARY OF THE INVENTION

The present invention provides a step stool for storing underneath a cabinet and extending therefrom when in use. The step stool includes a platform member for supporting a user. The platform member is manufactured from a first predetermined material and has a first predetermined size and a first predetermined shape. A means is operably disposed on at least one of a bottom portion of such platform member and at least one side of such platform member at a first predetermined location thereon for facilitating movement of the step stool such that the step stool may be extended from underneath such cabinet for use and may be returned to a position underneath such cabinet for storage.

### OBJECTS OF THE INVENTION

It is, therefore, one of the primary objects of the present invention to provide an easy to use step stool which is storable in a location convenient to a user.

Another object of the present invention is to provide a step stool which is stored below a cabinet and easily slides out from under such cabinet when in use and slides back under such cabinet for storage.

Another object of the present invention is to provide a step stool which has an outward appearance of a drawer within such cabinet.

Still another object of the present invention is to provide a wheeled step stool; the wheels stabilize and refrain from moving upon such step stool bearing a predetermined amount of weight.

Yet another object of the present invention is to provide a step stool that can be rolled out from under a cabinet to provide a step stool having at least one step.

An additional object of the present invention is to provide a step stool which can be pulled out from under a cabinet and pushed back under such cabinet and which may include a non-slip gripping surface on the stepping surface thereof.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention wherein such step stool includes wheels for facilitating movement and has a non-slip surface.

FIG. 2 is a partial perspective view of the invention according to one embodiment of the invention in which such step stool is securable to a cabinet by drawer slides.

FIG. 3 is a partial perspective view of the invention according to one embodiment of the invention in which such step stool is being housed under cabinetry and has a front panel with a handle.

FIG. 4 is a partial perspective view of the invention according to one embodiment of the invention in which the step stool has been attached to cabinetry using drawer slides.

FIG. 5 is a partial perspective view of the invention according to one embodiment of the invention in which the platform member has a first portion and a second portion; one of the portions can be raised for creating a step stool having two steps.

FIG. 6 is a partial perspective view of the invention according to one embodiment of the invention in which the second portion has been raised to create a second step for supporting a user.

FIG. 7 is a partial perspective view of the invention according to one embodiment of the invention.

FIG. 8 is a partial perspective view of the invention according to one embodiment of the invention.

FIG. 9 is a partial perspective view of the invention according to one embodiment of the invention.

FIG. 10 is a partial perspective view of the invention according to one embodiment of the invention.

FIG. 11 is a partial perspective view of the invention according to one embodiment of the invention.

FIG. 12 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

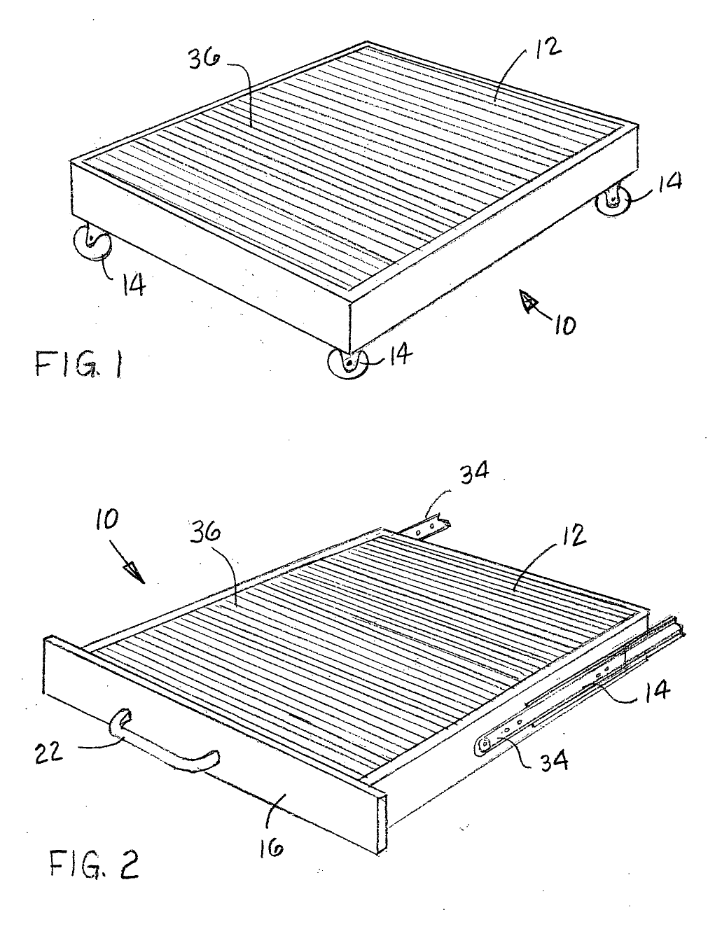

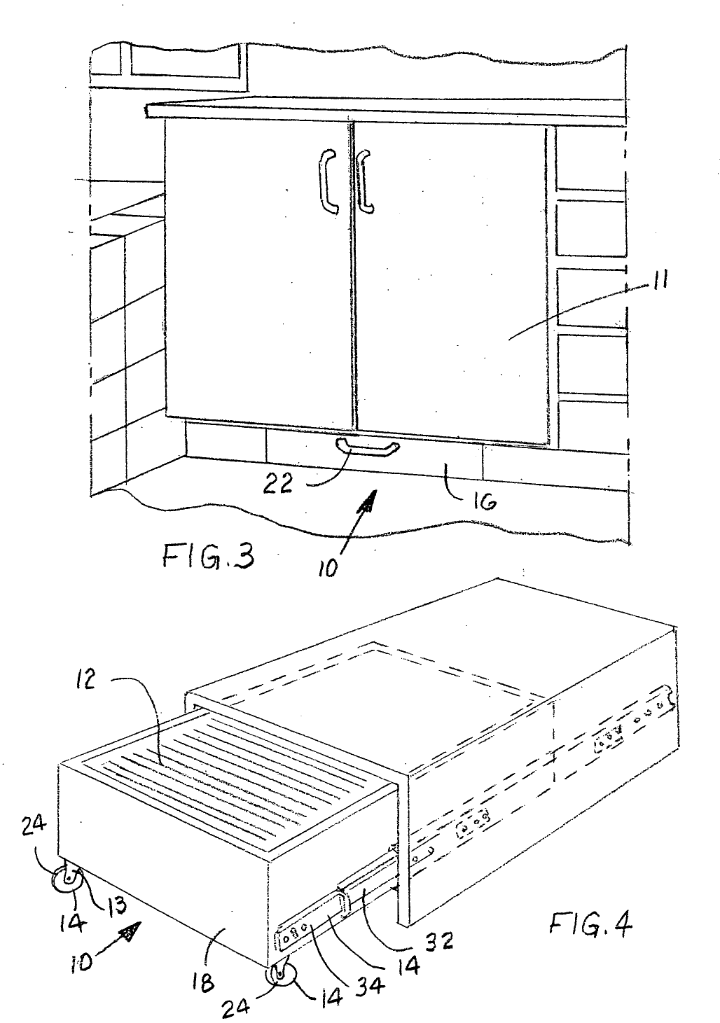

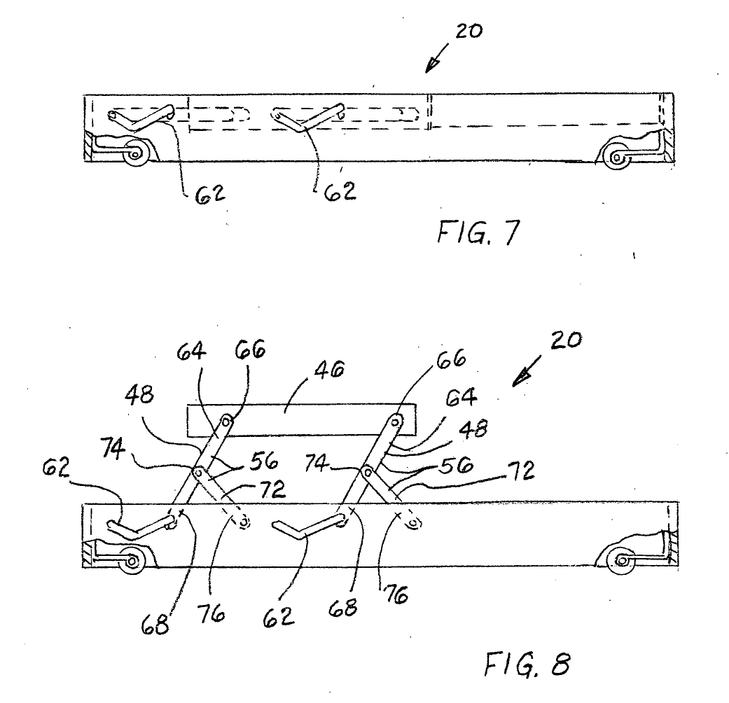

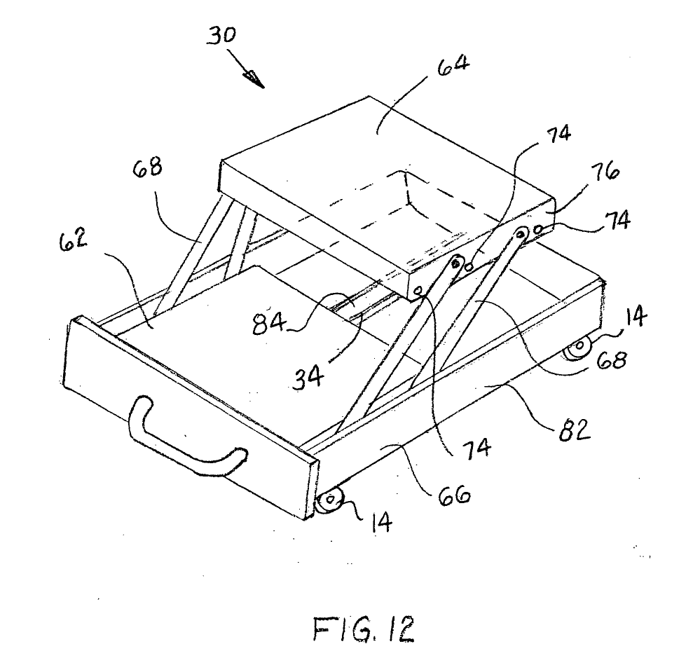

Reference is now made, more particularly, to FIG. 1-12.

Referring to FIGS. 1-4, a step stool, generally designated 10, for storing underneath a cabinet 11 and extending therefrom when in use is provided. Such step stool 10 includes a platform member 12 for supporting a user (not shown). The platform member 12 is manufactured from a first predetermined material and has a first predetermined size and a first predetermined shape.

A means 14 is operably disposed on at least one of a bottom portion of the platform member and at least one side of the platform member 12 at a first predetermined location thereon for facilitating movement of the step stool 10 such that the step stool 10 may be extended from underneath such cabinet 11 for use and may be returned to a position underneath such cabinet 11 for storage.

It is presently preferred that the step stool 10 further includes a panel member 16 manufactured from a second predetermined material and having a second predetermined size and a second predetermined shape, such panel member 16 being attached perpendicularly to a front side 18 of the platform member 12 at a predetermined location thereon. It is presently preferred that such second predetermined shape is substantially rectangular.

It is further presently preferred that such panel member 16 includes a handle member 22 operably connected thereto at a predetermined location thereon such that a user can utilize the handle member 22 to pull the step stool 10 out to an extended position and to return the step stool 10 to storage underneath such cabinet 11.

It is presently preferred that the at least one means 14 for facilitating movement of the step stool 10 includes at least one of at least one wheel member 24 operably disposed on a bottom surface of the platform member 12 at a predetermined location thereon and at least one drawer slide 34 operably connected to the platform member 12 and to such cabinet 11 at predetermined locations thereon. It is presently preferred that such step stool 10 includes four wheel members 24 operably disposed on a bottom surface of the platform member 12 at predetermined locations thereon.

It is presently preferred that such at least one wheel member 24 further includes a means 13 for disabling such at least one wheel member 24 from rolling when a predetermined amount of weight is born by the step stool 10.

It is presently preferred that a securing means 32 is operably connected to the platform member 12 at a second predetermined location thereon and to such cabinet 11 at a first predetermined location thereon for securing the step stool 10 to such cabinet 11.

It is presently preferred that such securing means 32 is a pair of drawer slides 34 operably connected to the platform member 12 and to such cabinet 11 at predetermined locations thereon. It is further presently preferred that such drawer slides 34 are side mounted drawer slides. It is presently preferred that such drawer slides 34 are ball bearing type drawer slides.

It is presently preferred that such platform member 12 includes a non-slip surface 36.

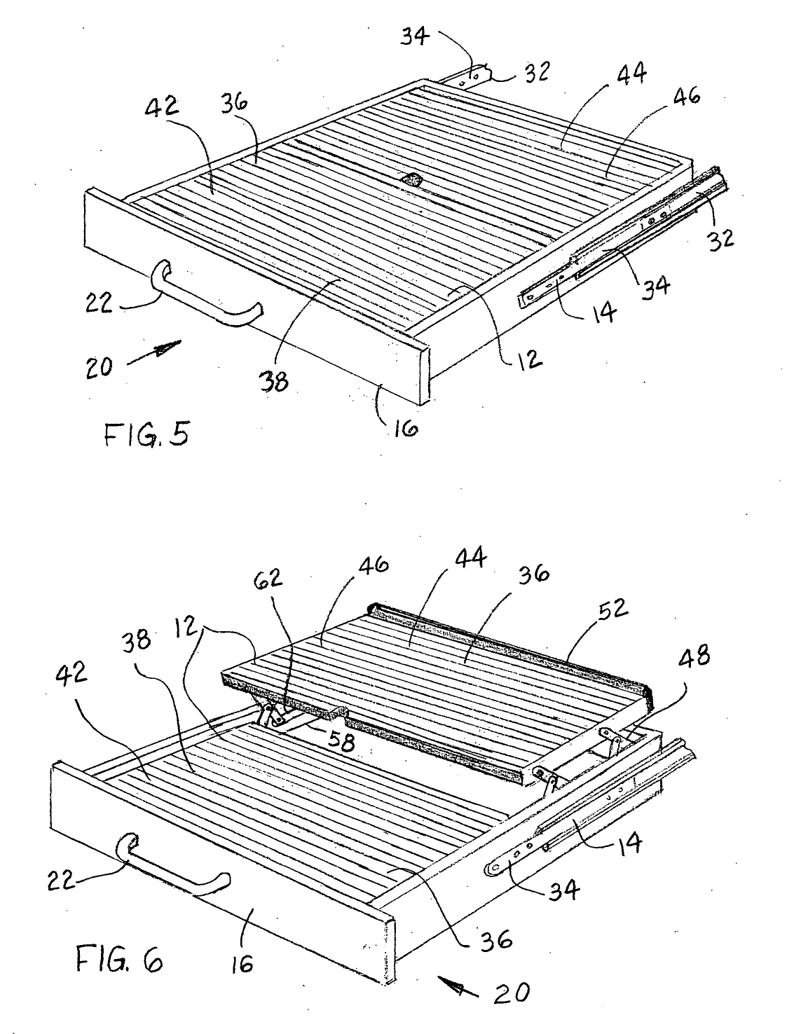

Referring to FIGS. 5-8, according to another embodiment of the invention, the step stool, generally designated 20, includes a platform member 12 having a first portion 38 for providing a first step 42 for supporting a user and a second portion 44 for providing a second step 46 for supporting a user at a height higher than that of the first step 42.

It is presently preferred that such second portion 44 further includes an extending means 48 for extending the second portion 44 from a first position wherein the second portion is flush with the first portion 38 to a second position wherein the second step 46 is at such height higher that that of the first step 42.

It is presently preferred that such extending means 48 includes mechanical pivoted linkages 56 acting between predetermined inner walls 58 of such platform member and such second step 46. The predetermined inner walls 58 have slots 62 therein. Such slots 62 have a predetermined size and a predetermined shape. Each of the pivoted linkages 56 includes an elongated first linkage arm 64 having opposite first and second ends. Such first linkage arm 64 at its first end 66 is pivoted to such second step and at its second end 68 being slidable along such slot 62. A shorter second linkage arm 72 is included. Such second arm 72 at one end 74 is pivoted to such first arm 64 between the first and second ends thereof and at its opposite end 76 is pivoted to the respective inner side wall 58 of such platform member in front of the respective slot 62.

It is further presently preferred that such second step 46 includes a covering member 52 operably disposed on a back edge 54 of such second step 46, the covering member 52 being manufactured from a third predetermined material and having a third predetermined shape and a third predetermined size. It is presently preferred that such third predetermined material is rubber.

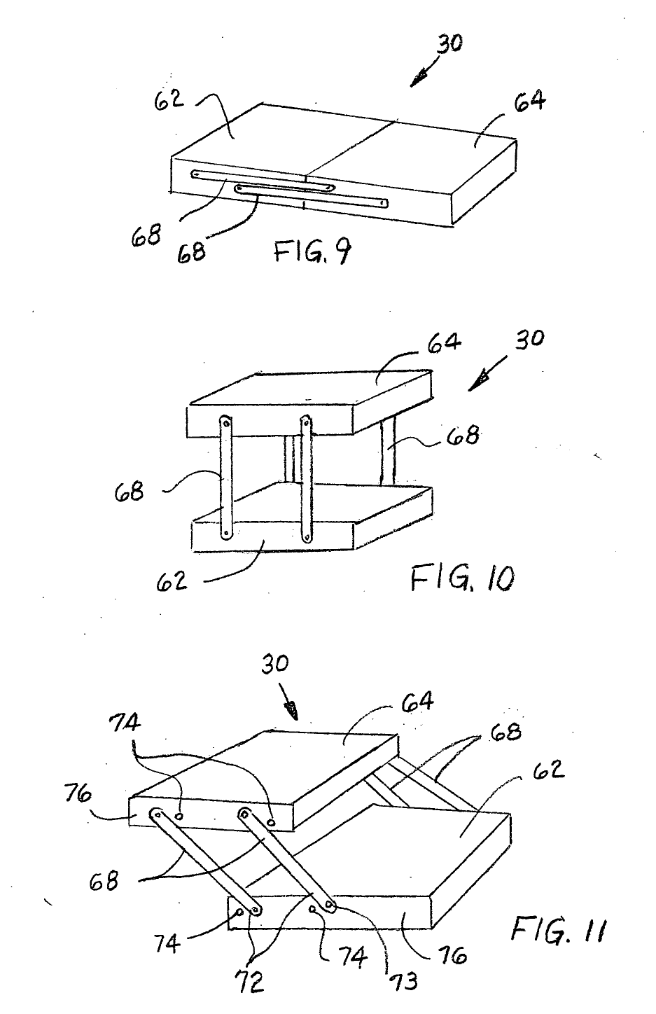

According to yet another embodiment, referring to FIGS. 9-12, a multi-step step-stool, generally designated 30, for storing underneath a cabinet and extending therefrom when in use is provided.

Such multi-step step stool 30 includes a first step member 62. A second step member 64 is disposed in a substantially coplanar position when not in use and is movable to an upward position as necessary, such second step member 64 being operably connected to the first step member 62 at a predetermined location thereon.

A means 66 is operably disposed on each of the first 62 and second 64 step members for supporting the first 62 and second 64 step members. A means 68 is operably disposed on the first step member 62 and the second step member 64 for pivoting such second step member into such upward position.

It is presently preferred that such means 68 for pivoting includes a plurality of arm members 72, pivot members 73 and stop members 74 operably disposed on respective side members 76 of such first 62 and second 64 step members at predetermined locations thereon such that the arm members 72 pivot a predetermined distance prior to reaching a resting point on the stop members 74.

It is presently preferred that such first step member 62 and the second step member 64 are disposed within a support member 82. It is presently preferred that at least said first step member is operably connected to said support member 82 at a predetermined location thereon by a sliding means 84 operably disposed on a predetermined portion of such support member 82. It is presently preferred that such sliding means 84 is at least one drawer slide 34.

A means 14 is operably disposed on at least one of a bottom portion of the support member 82 and at least one side of the support member 82 for facilitating movement of the support member such that the step stool 30 may be extended from underneath a cabinet 11 for use and may be returned to a position underneath such cabinet 11 for storage.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A step stool for storing underneath a cabinet and extending therefrom when in use, said step stool comprising;
a. a platform member for supporting a user, said platform member being manufactured from a first predetermined material and having a first predetermined size and a first predetermined shape; and
b. a means operably disposed on at least one of a bottom portion of said platform member and at least one side of said platform member at a first predetermined location thereon for facilitating movement of said step stool such that said step stool may be extended from underneath such cabinet for use and may be returned to a position underneath such cabinet for storage.

2. A step stool according to claim 1 wherein said step stool further includes a panel member manufactured from a second predetermined material and having a second predetermined size and a second predetermined shape, said panel member being attached perpendicularly to a front side of said platform member at a predetermined location thereon.

3. A step stool according to claim 2 wherein said second predetermined shape is substantially rectangular.

4. A step stool according to claim 2 wherein said panel member includes a handle member operably connected thereto at a predetermined location thereon such that a user can utilize said handle member to pull said step stool out to an extended position and to return said step stool to storage underneath such cabinet.

5. A step stool according to claim 1 wherein said at least one means for facilitating movement of said step stool includes at least one of at least one wheel member operably disposed on a bottom surface of said platform member at a predetermined location thereon and at least one drawer slide operably connected to said platform member and to such cabinet at predetermined locations thereon.

6. A step stool according to claim 5 wherein said step stool further includes four wheel members operably disposed on a bottom surface of said platform member at predetermined locations thereon.

7. A step stool according to claim 5 wherein said at least one wheel member further includes a means for disabling said at least one wheel member from rolling when a predetermined amount of weight is born by said step stool.

8. A step stool according to claim 1 wherein a securing means is operably connected to said platform member at a second predetermined location thereon and to such cabinet at a first predetermined location thereon for securing said step stool to such cabinet.

9. A step stool according to claim 8 wherein said securing means is pair of drawer slides operably connected to said platform member and to such cabinet at predetermined locations thereon.

10. A step stool according to claim 9 wherein said pair of drawer slides are a side mounted drawer slides.

11. A step stool according to claim 10 wherein said at pair of drawer slides are ball bearing type drawer slides.

12. A step stool according to claim 1 wherein said platform member includes a non-slip surface.

13. A step stool according to claim 1 wherein said platform member includes a first portion for providing a first step for supporting a user and wherein said platform member further includes a second portion for providing a second step for supporting a user at a height higher than that of said first step.

14. A step stool according to claim 13 wherein said second portion further includes an extending means for extending said second portion from a first position wherein said second portion is flush with said first portion to a second position wherein said second step is at said height higher than that of said first step, and for returning said second step to said first position from said second position.

15. A step stool according to claim 14 wherein said second step includes a covering member operably disposed on a back edge of said second step, said covering member is manufactured from a third predetermined material and has a third predetermined size and a third predetermined shape.

16. A step stool according to claim 15 wherein said third predetermined material is rubber.

17. A step stool according to claim 14 wherein said extending means includes mechanical pivoted linkages acting between predetermined inner walls of said platform member and said second step and wherein said predetermined inner walls have slots therein, said slots having a predetermined size and a predetermined shape, and wherein each of said pivoted linkages includes an elongated first linkage arm having opposite first and second ends, said first linkage arm at its first end being pivoted to said second step and at its second end being slidable along said slot, and a shorter second linkage arm which at one end is pivoted to said first arm between said first and second ends thereof and at its opposite end is pivoted to the respective inner side wall of said platform member in front of the respective slot.

18. A multi-step step-stool for storing underneath a cabinet and extending therefrom when in use, said step stool comprising;
a. a first step member;
b. a second step member disposed in a substantially coplanar position when not in use and movable to an upward position as necessary, said second step member being operably connected to said first step member at a predetermined location thereon;
c. means operably disposed on each of said first and second step members for supporting said first and second step members; and
d. means operably disposed on said first step member an said second step member for pivoting said second step member into said upward position.

19. A multi-step step stool according to claim 18 wherein said means for pivoting includes a plurality of arm members, pivot members and stop members operably disposed on respective side members of said first and second step members at predetermined locations thereon such that said arm members pivot a predetermined distance prior to reaching a resting point on said stop members.

20. A multi-step step stool according to claim 19 wherein said first step member and said second step member are disposed within a support member such that said first step member is operably connected to said support member at a predetermined location thereon by a sliding means, said sliding means being operably disposed on a predetermined portion of said support member and wherein a means is operably disposed on at least one of a bottom portion of said support member and at least one side of said support member for facilitating movement of said support member such that said multi-step step stool may be extended from underneath a cabinet for use and may be returned to a position underneath such cabinet for storage.
